(19) United States
(12) Patent Application Publication
(10) Pub. No.: US 2012/0072312 A1
(43) Pub. Date: Mar. 22, 2012

(54) Curated Application Store

(75) Inventors: Danny Lange, Sammamish, WA (US); Matthew Graham Dyor, Bellevue, WA (US); Joseph Futty, Sammamish, WA (US); John Bruno, Snoqualmie, WA (US); Viswanath Vadlamani, Sammamish, WA (US); John Clavin, Seattle, WA (US)

(73) Assignee: MICROSOFT CORPORATION, Redmond, WA (US)

(21) Appl. No.: 12/887,728

(22) Filed: Sep. 22, 2010

(51) Int. Cl. G06Q 30/00

(52) U.S. Cl. 705/27.1

(57) ABSTRACT

A curated application store is a virtual storefront that includes applications provisioned from one or more application databases. For example, a curator may browse through an application database to find notable applications based on his or her expertise in a certain area and then provision the notable applications from the application database for inclusion in an application store curated by the curator. Accordingly, users browsing for applications pertaining to the area of expertise of the curator may shop for the applications from within a virtual application mall which includes a collection of curated application stores such as the application store curated by the curator. In return, the curator of the store may receive a revenue share from the purchases made within his or her application store.

### BACKGROUND

With the increasing popularity of smart mobile devices, or mobile devices with built in operating systems, computer program developers have generated a multitude of applications (or “Apps”) available to the mobile device consumer. For instance, consumers of Microsoft® platforms such as the Windows® Phone devices have access to a multitude of applications pertaining to everything from reference applications (i.e., a dictionary application or language translation application) to productivity applications from the Windows® Marketplace. Similarly, consumers of Apple® platforms such as the iPhone have access to a multitude of applications from the Apple® App Store and consumers of Android® platforms have access to applications from the Android® Market.

Although the application stores such as Windows® Marketplace, Apple® App Store, and Android® Market may organize the applications into categories, as the number of available applications continues to grow, it may be difficult for a user to search through the applications. For example, if a user is a gardener and they desire to download an application on how to grow an organic garden, the user may perform a search within the Apple® App Store on “gardening.” However, the search may result in an overwhelming number of applications related to gardening making it difficult for the user to sort through the applications to find the desired applications.

### BRIEF SUMMARY

This Summary is provided to introduce simplified concepts for a curated application store, which are further described below in the Detailed Description. This summary is not intended to identify essential features of the claimed subject matter, nor is it intended for use in determining the scope of the claimed subject matter. This disclosure relates to curating an application store to include applications available from application databases such as Windows® Marketplace, Apple® App Store, and Android® Market. Thus, a user browsing for an application can browse for the application from within a curated application store rather than having to browse through an entire application database.

In general, curators of the application stores have some level of expertise regarding the applications that are available from the curated application store. For example, a curator who is an expert in gardening may curate a Gardening Application Store. The curator may first search through application databases (e.g., Windows® Marketplace, Apple® App Store, Android® Market, etc.) to find notable gardening applications. The curator may provision the notable gardening applications to include in the Gardening Application Store. Users browsing the Gardening Application Store may then purchase the applications from the Gardening Application Store. Thus, rather than the users having to search for gardening applications in an application database, which may return an overwhelming number of results, the user may rather shop for gardening related applications from the Gardening Application Store. In the Gardening Application Store, the user can have at least some confidence that the applications available in the Gardening Application Store have been approved by the curator who presumable has some level of expertise in gardening. In return, the curator of the store may receive a revenue share from the purchases made within the application store. In this way, both the curator of the application store and the developer who developed the applications which are available from the curated application store may be able to benefit from the revenue shares. In addition, the users will benefit because they will be able to quickly find applications which have been personally recommended by a curator who has an implicit level of expertise in an area without having to browse through the multitude of applications that are available from a large application database.

In addition to downloading the applications from the application store, the user may download the application storefront so that the user can then receive updates from the curator of the store such as when new applications are made available within the application store, or when new transactions are offered. This way, the user can keep up to date on the most recent gardening related applications.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 is a schematic diagram of an illustrative environment usable to make application stores available to users.

FIG. 2 is a schematic diagram illustrating an example of curation of application stores.

FIG. 3 is a pictorial flow diagram showing illustrative processes to generate application stores.

FIG. 4 is a pictorial flow diagram showing illustrative processes to purchase application stores.

FIG. 5 is an illustrative target device interface depicting a home screen view.

FIG. 6 is an illustrative target device interface depicting an application mall view.

FIG. 7 is an illustrative target device interface depicting an application store view.

FIG. 8 is an illustrative target device interface depicting a selected application view.

FIG. 9 is an illustrative target device interface depicting an application store general information view.

FIG. 10 is a block diagram of an illustrative computing device and application store provider to make application stores available.

FIG. 11 is a block diagram of an illustrative target device to browse for applications from an application store.

### DETAILED DESCRIPTION

### Overview

As noted above, it is often difficult for a user to find desired applications from an application database which may store a large number of applications. This difficulty is compounded by the fact that application developers are constantly adding new applications to the application databases such that the number of total applications available from the application databases continues to grow daily.

This disclosure describes a curated application store that is populated with applications from an application database. The curated application store may offer comments or reviews of the applications available from the curated application store and/or the application store itself. For instance, a curator of the store and/or patrons of the application store such as a user or customer may offer the comments or reviews based on their thoughts or experiences regarding the available applications and/or the application store. The curator may additionally specify policies for the application store including, for example, policies pertaining to returning applications purchased from the application store, transferring applications purchased from the application store, and subscribing to the application stores. The various application stores created by one or more curators may be stored to a central application store catalog so that the application store catalog may be accessed by users who are interested in browsing or purchasing applications.

The application stores stored to the application store catalog may be presented to the users as a mall front which may be simply a collection of application stores which are each visually represented by an icon. Thus, similar to how one may browse through an application database such as the Apple® App Store for applications, the users of the present disclosure may browse the application store catalog for curated application stores.

The application stores displayed in the mall front may be filtered before they are displayed so that a user shopping for applications in the mall front is only presented with compatible application stores. For example, a user of a Microsoft® platform that is shopping for travel applications in the mall front will only be able to see the travel application stores that are compatible with the Microsoft® platform. However, in other examples, a user who is physically located in Seattle while shopping for applications will not be able to see applications which are specific to an area that it is not associated with Seattle. Or, in another example, an English speaking user may only be able to see applications which are targeted to an English speaking audience.

If a user desires to view the applications that are available from any of the displayed application stores, they may simply select an application store of interest to display a storefront of the selected application store. The storefront may include the applications which are available from the selected application stores. The storefront may additionally include any specific policies or customer support options such as, for example, policies pertaining to returning items purchased from the application store, transferring items purchased from the application store, and purchasing one of the application stores.

The applications available from within the application stores may be filtered before they are displayed so that a user shopping for applications is only presented with compatible applications. For example, a user of a Microsoft® platform device that is shopping for travel applications at a Travel Application Store which includes a combination of Microsoft® platform applications, Apple® platform applications, and Android® platform applications, will only be able to see the travel applications that are compatible with the Microsoft® platform. Alternatively, the application stores may be filtered based on multiple devices. For instance, a user who has multiple devices such as a Microsoft® platform device and an Apple® platform device may be displayed with Microsoft® platform applications and Apple® platform applications regardless.

The techniques of the present disclosure enable a user to download applications directly from the application store rather than downloading the applications from an application database. In this way, both the curator of the application store and the developer who developed the applications which are available from the curated application store may be able to benefit from the revenue shares. In addition, the users will benefit because they will be able to quickly find applications which have been personally recommended by a curator who has a level of expertise in an area. The level of expertise may vary. Examples of curators include, but are not limited to, recognized experts in a field (e.g., Martha Stewart), companies specializing in an area, self proclaimed experts in a field, organizations (e.g., The Sierra club), a company store for employees, etc.

### Illustrative Application Store Environment

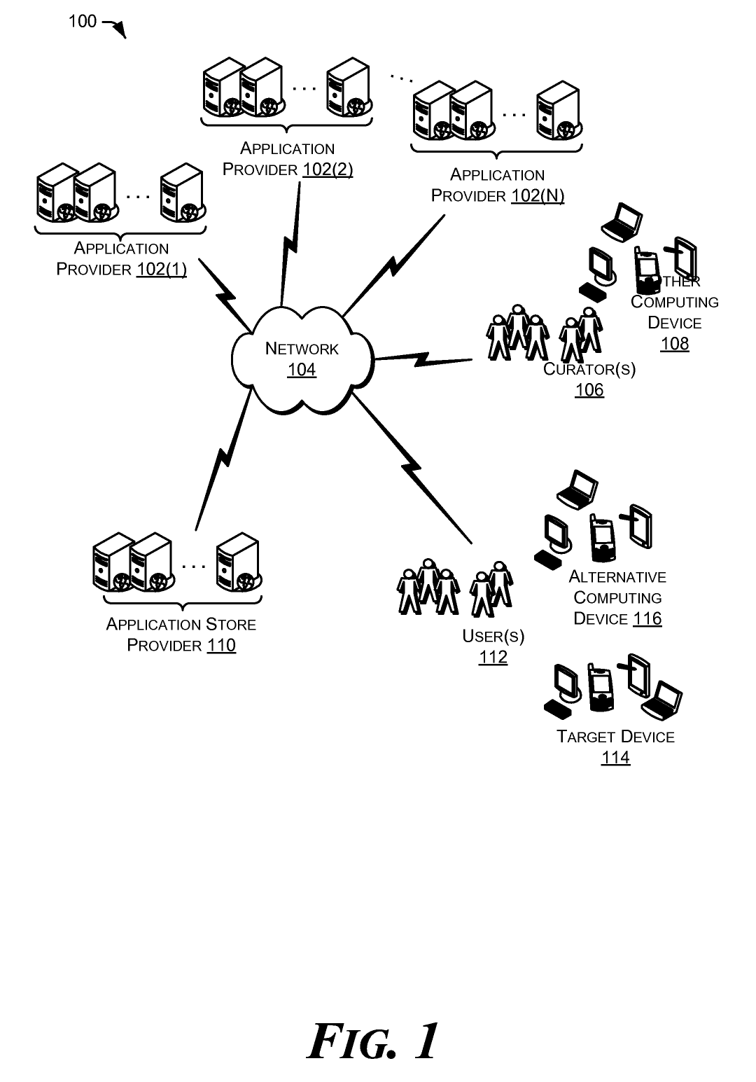

FIG. 1 is a schematic diagram of an illustrative environment 100 to provide application stores to users. Environment 100 includes one or more application provider(s) 102(1), 102(2), . . . , and 102(N), (collectively 102) which are communicatively coupled via a network 104. One or more curator(s) 106, each operating a respective computing device 108, may provision notable applications from one or more of the application providers 102(1)-(N) via the network 104. The curator 106 may further operate the computing device 108 to curate one or more application stores using at least a portion of the notable applications provisioned from the application providers 102(1)-(N). The curated application stores may then be stored to any node of the network 104. For instance, the curated application stores may be stored to an application catalog resident at an application store provider 110. Alternatively, the curated application store may be stored to any one of the application providers 102(1)-(N) and/or the computing device 108.

One or more user(s) 112 may operate a target device 114 or an alternative computing device 116 to browse the curated application stores and purchase content from the curated application stores for use at the target device 114. For example, if the target device 114 is a mobile phone, the user 112 may use the mobile phone to both browse and directly purchase an application from a curated application store to use on the mobile phone. Alternatively, the user 112 may operate an alternative computing device 116, such as a personal laptop to purchase an application that the user intends to use on the mobile phone. The target device 114, the alternative computing device 116, the application store provider 110, or any other device storing curated application stores may be operable to download content purchased from a curated application store to the target device 114. In some instances, the user may purchase the entire application store for use at the target device 114. Purchasing the application store may enable the user to stay connected to the application store. For instance, the user 112 may purchase the application store to receive updates from the curator of the store such as when new applications are made available within the application store or when new transactions are offered. Through this purchased membership of the application store, the user can keep up to date on the most recent applications available, available updates, and other news.

Each of the respective nodes coupled to the network 104 may be communicatively coupled to other nodes of the network using known communication connections and protocols. The network 104 may be a wired and/or wireless communication network such as the Internet, one or more wide area networks (WANs), local area networks (LANs), and/or personal area networks (PANs).

Application providers 102(1)-(N) may include any sort of entity (e.g., databases, web sites, etc.) that can store applications to one or more application databases. The application store provider 110 may be configured as any suitable computing device capable of storing data and communicating application stores to the target devices 114. By way of example and not limitation, suitable computing devices may include personal computers (PCs), servers, server farms, datacenters, or any other devices configured as a processor, memory, and a network connection. The devices 108, 114, and 116 may include any sort of device capable of performing input/output operations necessary to browse through the application stores and download content from the application stores. For instance, the devices 108, 114, 116 may include personal computers, laptop computers, mobile phones, set-top boxes, game consoles, personal digital assistants (PDAs), portable media players (PMPs) (e.g., portable video players (PVPs) and digital audio players (DAPs)), net books, tablet PCs, and other types of computing device.

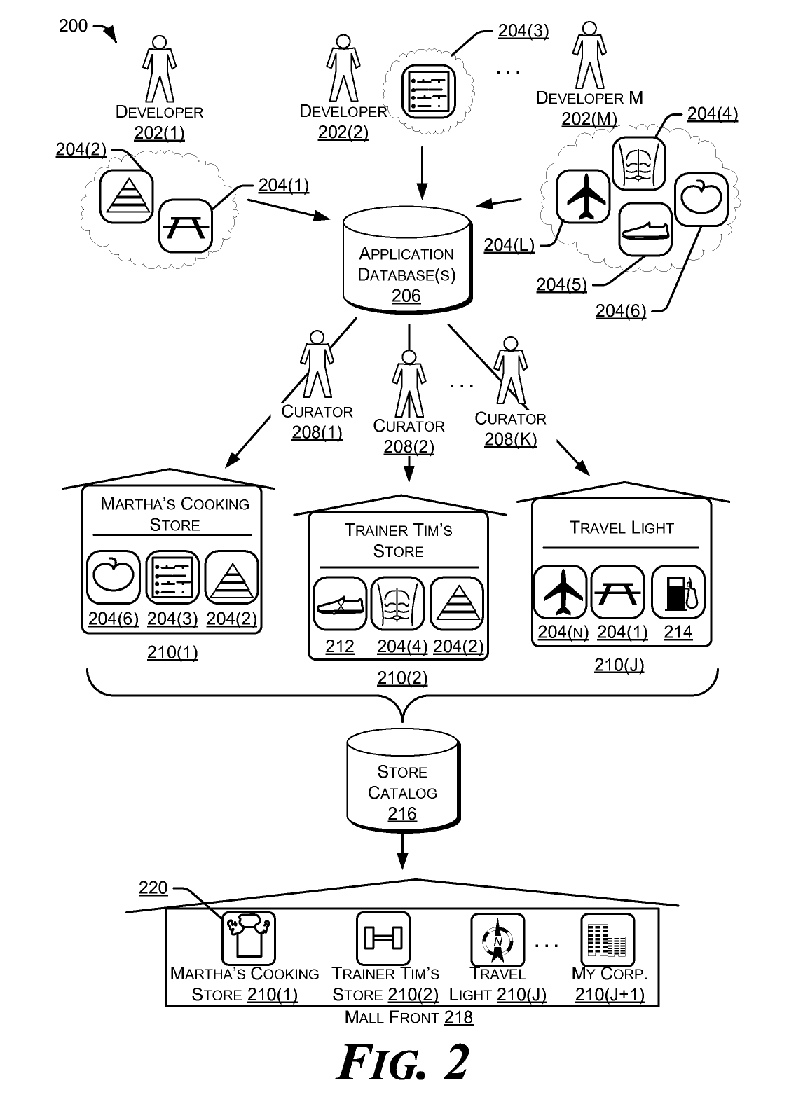

FIG. 2 is a schematic diagram of an illustrative technique 200 of populating an application store catalog with application stores. One or more developers 202(1), 202(2), . . . , and 202(M) may develop applications one or more applications. For example, developer 202(1) may develop a Park Finder Application 204(1) and a Food Log Application 204(2). Developer 202(2) may develop a Grocery List Application 204(3). Developer 202(M) may develop a 12 Minute Abs Application 204(4), a Running Trail Finder Application 204(5), a Healthy Recipe Application 204(6), and a Flight Tracker Application 204(L). The applications 204(1)-(L) developed by developers 202(1)-(M) may be stored to one or more application database(s) 206.

The application database 206 may be a single database or multiple databases resident on one of the application providers 102(1)-(N), resident on the application store provider 110, or resident on any combination of the application providers 102(1)-(N) and/or the application store provider 110.

One or more curators 208(1), 208(2), . . . , and 208(K) may interface with the application database 206 to curate application stores 210(1), 210(2), . . . , and 210(J), respectively. For example, curator 208(1) may curate a cooking application called Martha's Cooking Store 210(1). Curator 208(2) may curate an athletic based training store application called Trainer Tim's Store 210(2). Curator 208(K) may curate a travel store application called Travel Light 210(J). Each of the application stores 210(1)-(J) may include a collection of applications provisioned form the application database 206 by the respective curators 208(1)-(K). For example, the Martha's Cooking Store 210(1) may additionally include the Healthy Recipe Application 204(6) developed by developer 202(M), the Grocery List Application 204(3) generated by developer 202(2) and the Food Log Application 204(4) generated by developer 202(1).

In some instances, the curators 208(1)-(K) may alter the applications after they are provisioned from the application database 206. For example, the curators 208(1)-(K) may alter the applications after they are provisioned from the application database 206 to re-brand the provisioned applications to include brandings associated with either the curator or the application stores.

For example, the Trainer Tim's Store 210(2) may include a Tim Trainer Running Trail Finder Application 212 that is based on the Running Trail Finder Application 204(5) but has been re-branded to include brandings associated with curator Tim. The Trainer Tim's Store 210(2) may additionally include the 12 Minute Abs Application 204(4) and the Food Log Application 204(2). Alterations may be limited by copyright laws, agreements with the developer, agreements with an administering the application mall, etc.

In some instances, the applications may be developed or generated specifically to be included in a curated application store (e.g., “contracted applications”) and thus such contracted applications may be available only from the application store and not available from the application database 206. For example, the Travel Light Store 210(J) may include the Flight Tracker Application 204(L), the Park Finder Application 204(1), and a Gas Price Comparer Application 214 which is a contracted application that is developed specifically for the Travel Light store 210(J).

The curators 208(1)-(K) may operate computing device 108 to provision the applications 204(1)-(L) from the application database 206. In some instances, the curators 208(1)-(K) pay a fee to provision the applications from the application database 206. In return, the curators 208(1)-(K) may generate a revenue share from the application stores by re-selling the purchased applications to customers of the application stores.

The curators 208(1)-(K) may either hand select the applications to be included in the respective application stores 210(1)-(J) or the curators may use a computer algorithm to find the applications. In the event that the curators 208(1)-(K) hand select the applications, the application stores may include a collection of applications that could not readily be found using a computing algorithm. Rather, the curators 208(1)-(K) may use his or her specific expertise to find notable applications which consumers may be interested in purchasing.

As discussed above, the curators 208(1)-(K) may be an individual or an organization. For instance, curator 208(1) (i.e., Martha) may be a famous chef who populates the Martha's Cooking Store 210(1) with applications that Martha feels cooking enthusiasts will be interested in purchasing. In this way, Martha may use her popularity as a famous chef to attract cooking enthusiasts to purchase cooking related applications from her application store. In this way, both Martha and the developer of the applications sold in Martha's Cooking Store will be able to benefit from the revenue shares generated by the sales which are made from Martha's Cooking Store. In addition, the cooking enthusiast users will benefit because they will be able to quickly find cooking related applications which are personally recommended by a famous chef without having to browse through the multitude of cooking related applications that they may be presented with if they were to search for “cooking” in a large application database such as the Apple® App Store database, for example.

In some instances, the curators 208(1)-(K) are not affiliated with a party administering the application database 206 from which the curators provisioned the applications. For example, suppose a curator is provisioning all applications from the Apple® App Store such that the curator is curating an application store that is populated only with applications compatible with an Apple® platform device. In such instances, the curator may be an entity (i.e., an individual or organization) that is not affiliated with Apple®. However, in other instances, the curator may be affiliated with the application database 206.

The application stores 210(1)-(J) may be stored to the application store catalog 216 along with an icon that visually represents each of the application stores, respectively. The collection of application stores in the application store catalog 216 may be presented to the users 112 as a mall front 218 which may be a collection of application stores which are each visually represented by an icon, thumbnail, or other designator. For instance, similar to how one may browse through an application database such as the Apple® App Store for applications, the users 112 may browse the application store catalog 216 for curated application stores. For example, customers browsing within the application store catalog 216 may come across the Martha's Cooking Store Application 210(1) which may be visually represented by an apron icon 220, the Trainer Tim's Store 210(2), the Travel Light Store 210(J), and a My Corporation Store 210(J+1).

The My Corporation Store 210(J+1) may be curated by an employer and may include applications which are applicable to employees of the employer. For example, Microsoft® may generate a My Microsoft Store that includes applications that are applicable to Microsoft® employees such as applications that enable the employees to view recent paystubs. Some of these applications may recommended publicly available applications (such as a weather or news application) while others are company proprietary (Line of Business applications). The My Corporation Store may or may not require an authorization credential (e.g., employee ID, username and password, etc.) to access. Additionally, the applications in the My Corporation Store may be provided to users for free or at a discount.

The application stores may be organized into one or more mall fronts. For instance, there may be an outlet mall front which includes applications stores offering discounted merchandise, an antique mall front that includes application stores offering antique related goods, sports mall front that includes sports related application stores, etc. In some instances, the mall fronts are stored to the store catalog 216. Alternatively, the mall fronts are stored to another database that is connected to the network 104.

### Illustrative Process

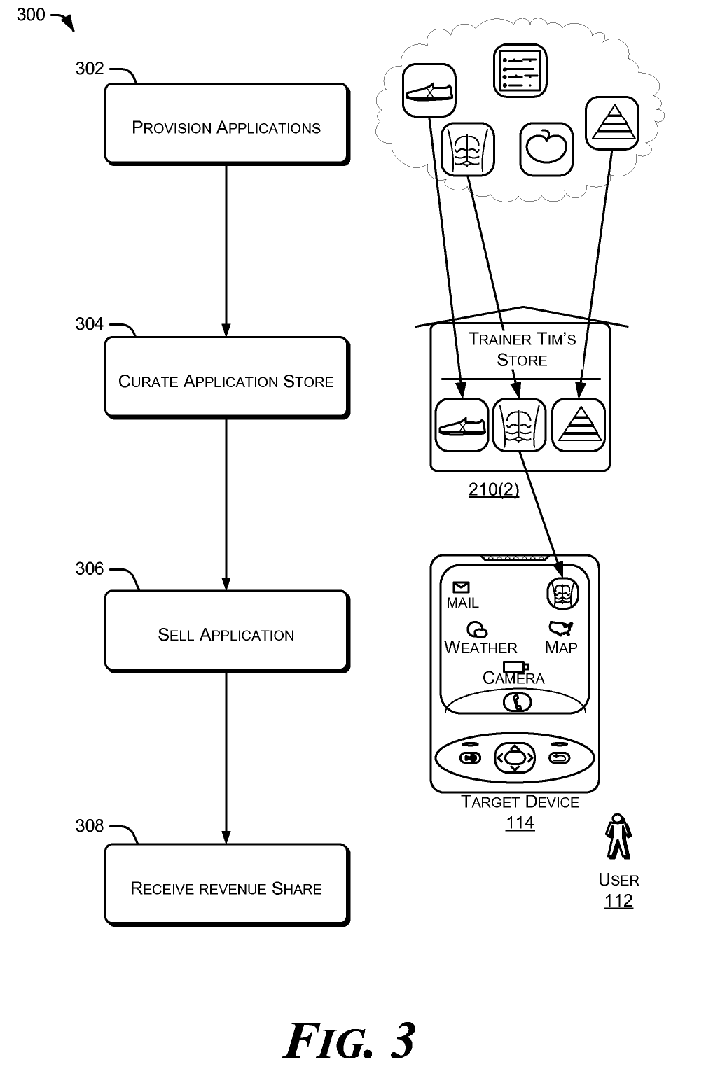

FIG. 3 is a pictorial flow diagram showing an illustrative process 300 of generating application stores. The process 300 may, but need not necessarily, be implemented by the curator computing devices 108.

The process 300 is illustrated as a collection of blocks in a logical flow graph, which represent a sequence of operations that can be implemented in hardware, software, or a combination thereof. In the context of software, the blocks represent computer-executable instructions that, when executed by one or more processors, cause the one or more processors to perform the recited operations. Generally, computer-executable instructions include routines, programs, objects, components, data structures, and/or other types of executable instructions that perform particular functions or implement particular abstract data types. The order in which the operations are described is not intended to be construed as a limitation, and any number of the described blocks can be combined in any order and/or in parallel to implement the process. Other processes described throughout this disclosure, in addition to process 300, shall be interpreted accordingly.

At 302, the curator 106 provisions one or more applications either by hand-selecting the applications or automatically such a by using a computer algorithm. For example, if the curator 106 is a personal trainer such as Tim, the curator of the Trainer Tim's Store 210(2), then Tim may desire to provision applications pertaining to fitness. For instance, Tim may provision weight lifting applications, yoga based applications, running applications, exercise log applications, etc. In addition, Tim may also provision applications pertaining to health and diet since it is likely that consumers interested in personal training are also interested in eating healthy. As illustrated in FIG. 3, Tim provisions the Running Trail Finder Application 204(5) but re-brands it into the Tim Trainer Running Trail Finder Application 212 by adding brandings associated with curator Tim. Tim additionally provisions the Grocery List Application 204(3), the 12 Minute Abs Application 204(4), the Healthy Recipe Application 204(6), and the Food Log Application 204(2).

The curator 106 may provision the applications from the application database 206 or the curator may provision the applications directly from an application developer such as the developers 202(1)-(M). In some instances, the curator 106 operates the computing device 108 to provision the applications from the application database 206. In some instances, the curator 106 may pay a fee to provision the applications. The curators may have a license agreement with the developer of the provisioned applications. For instance, the license agreement may grant or limit rights to modify the provisioned applications. The license agreement may be effective during the provisioning or after the provisioning.

At 304, the curator 106 curates the application store using at least a portion of the applications provisioned at 302. The curator 106 may evaluate the provisioned applications to determine which of the provisioned applications the curator would recommend to a consumer. For example, curator Tim may evaluate the Tim Trainer Running Trail Finder Application 212, the Grocery List Application 204(3), the 12 Minute Abs Application 204(4), the Healthy Recipe Application 204(6), and/or the Food Log Application 204(2). In evaluating these applications, Tim may determine that the Tim Trainer Running Trail Finder Application 212, the 12 Minute Abs Application 204(4), and the Food Log Application 204(2) are notable applications. However, the Grocery List Application 204(3) and the Healthy Recipe Application 204(6) were not notable. Accordingly, Tim may curate the Trainer Tim's Store 210(2) using only the notable applications (e.g., the Tim Trainer Running Trail Finder Application 212, the 12 Minute Abs Application 204(4), and the Food Log Application 204(2).

In some instances, the application store may offer comments or reviews of the applications available from the curated application store and/or the application store itself at 304 to assist a user browsing the application store. The comments or reviews may be manufactured by either the curator 106 or by patrons of the application store. For example, the curator 106 may offer reviews that include specific features of the applications which the curator feels are notable. In addition, the application store may rank the applications included in the application store and/or the application store itself at 304 using any ranking method such as numerical score (i.e., rank the applications from 1-10 where 10 is the strongest store) or a visual score (i.e., providing 1-5 stars where the more stars represent the higher ranked applications). Similar to the reviews, the rankings may be manufactured by the curator 106 and/or by patrons of the application store such as users or customers.

In some instances the curator 106 may associate one or more policies or customer support options with the curated application store at 304. For instance, when curating the application store, the curator 106 may establish a return policy enabling a return of a purchased application, a transfer policy enabling a transfer of a purchased application, a subscription policy enabling a rental or trade-in of the applications available from the application store, or any combination thereof. For example, if a user who purchases an application later determines that he does not like the application or that the application is not what he thought it was, then he may return the purchased application if enabled by the return policy. This may be similar to how a consumer may return a pair of running shoes back to the physical running store from which he purchased the shoes if the consumer later discovers that he accidently purchased the wrong size. In such instances, the user may receive a full or partial refund or store credit of the purchase price of the application upon returning it back to the curator 106. As another example, the transfer policy may enable a purchaser of an application to transfer the purchased application to another user if the purchaser later determines that he no longer has a use for the purchased application. This may be similar to how a consumer may sell the treadmill he received for his birthday two years ago but which has only been used as a spacious sweater rack to his neighbor at the garage sale. As a further example, the subscription policy may enable users to pay a one time or reoccurring subscription fee and in return, the users are able to “rent” the applications from the application store for a limited duration of time and then later “trade-in” the rented application for a replacement application.

At 306, the curator 106 sells one or more of the applications from the application store. The curator 106 may sell the applications to the users 112 via the network 104 for use on the target device 114. The users 112 may purchase the applications directly from the target device 114 or the users may purchase the applications using the alternative computing device 116.

At 308, the curator 106 receives a revenue share from selling the application. In some instances, the revenue share received from the sale is different than a price that the curator paid to provision the application.

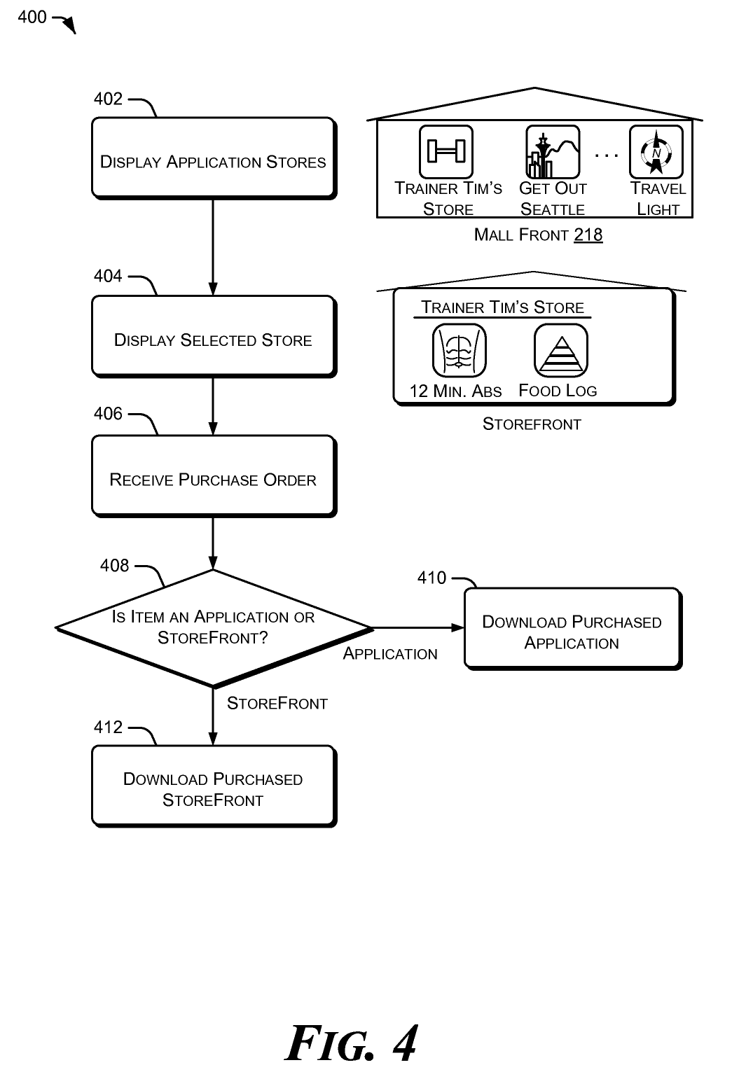

FIG. 4 is a pictorial flow diagram showing an illustrative process 400 of purchasing items from the store catalog 216. The process 400 may, but need not necessarily, be implemented by the target device 114, the alternative computing device 116, or any combination thereof to purchase items from the application store for use on the target device 114.

At 402, the mall front 218 of application stores is displayed. The application stores included in the mall front may be retrieved from the store catalog 216. In some instances, the mall front 218 is displayed in response to receiving a selection of an application mall command from the user 112. In other words, the user 112 may select an application mall icon via either the target device 114 or the alternative computing device 116 indicating that he or she desires to browse the for applications from the mall front 218. This may be similar to how a user may select the Windows® Marketplace icon to view a list of Windows® Phone applications. However, instead of displaying applications, the process 400 displays the mall front 218 which includes a listing of application stores 210.

As shown in FIG. 4, the mall front 218 includes the Trainer Tim's Store, a Get Out Seattle Store, the Travel Light Store, etc. In some instances, the application stores are filtered at 402 prior to being displayed. The applications may be filtered according to parameters such as target device location, target device platform, language preference, user profile (e.g., user's age, likes or dislikes of the user), user roles (e.g., “mother,” “student,” “caretaker,” etc.), user employer, search history, time (e.g., time of day, month, year, season, etc.), purchase history, device owned by the user (e.g., Windows Phone Device, X-Box, iPhone, etc.) and so forth. In this way, users browsing the mall front 218 will only be presented with compatible application stores. For example, only users who are within the Seattle area will be able to see the Get Out Seattle Store since the Get Out Seattle Store is a location specific store. In other words, it would not make sense for a user in London, England to be presented with the Get Out Seattle Store since they are likely not interested the applications which are available from that store. That is, unless, the users recent search history or purchase history indicates an interest in Seattle (e.g., if the user were planning a trip to Seattle). The process 400 may automatically filter the application stores using data stored to the target device 114. Alternatively, the process 400 may request additional data at 402, such as from the user 112, in order to filter the application stores.

At 404, an application store is selected from the mall front 218 to display a storefront of the selected application store. For example, if the Trainer Tim's Store is selected, then a storefront of the Trainer Tim's Store 210(2) is displayed at 404. The storefront may include one or more applications that are provisioned by the curator of the selected application store and are available from within the application store. For example, the storefront of the Trainer Tim's Store 210(2) includes the 12 Minute Abs Application 204(4) and the Food Log Application 204(2).

In some instances, the applications displayed in the storefront are filtered at 404 prior to being displayed. The applications may be filtered similar to the filtering of the application stores at 402 such that only the compatible applications are displayed to the storefront.

At 406, a purchase order is received. For instance, the user 112 may indicate an item that he or she desires to purchase (e.g., an application or the storefront) from the application store and accordingly a purchase order corresponding to the item may be received at 406.

At 408, the process 400 determines whether the item being purchased is the storefront or one or more applications that are available from the application store. If the item being purchased is one or more applications (i.e., the “application” branch at element 408), then process 400 continues to 410 where the one or more purchased applications are downloaded to the target device 114. If the item being purchased is an application store (i.e., the “store branch” at 408), then process continues to 412 where the storefront of the application store is downloaded to the target device 114. Purchasing the storefront may enable the user to stay connected to the application store. For instance, the user 112 may purchase the storefront to receive updates from the curator of the store such as when new applications are made available within the application store, or when new transactions are offered. This way, the user can keep up to date on the most recent applications.

For example, if the user purchases a storefront of an application store and then the curator 106 adds a new application to that application store, then the user may automatically receive notifications alerting that a new application is available for purchase from the application store. The user may then simply browse the new application directly from the downloaded storefront without having to go through the mall front.

### Illustrative Target Device Interface

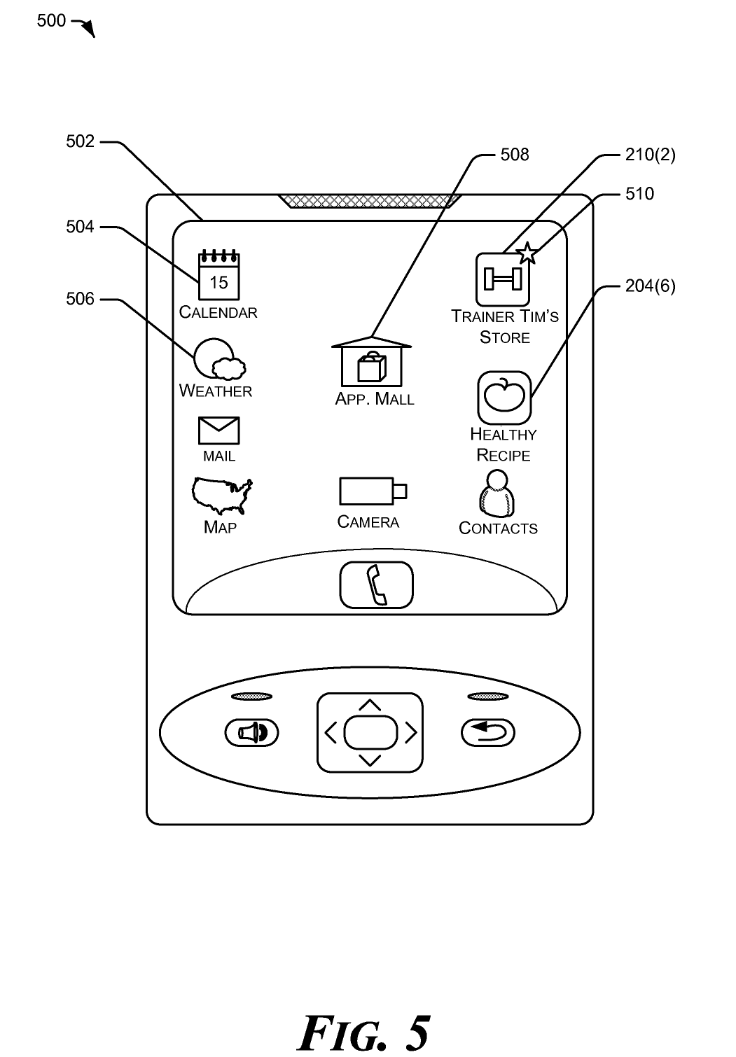

FIGS. 5-9 show various user interface embodiments that utilize the target device 114 to interface with the application stores. Although FIGS. 5-9 illustrate the target device 114 being a mobile device, the target device is not limited to being a mobile device. Rather, the target device 114 may be any computing device operable to display and interface with the application stores.

FIG. 5 is a front view of an illustrative device 500 that displays a home screen 502 to a display of the device. In some embodiments, the home screen 502 includes selectable links such as a calendar 504, a weather forecaster 506, etc. The home screen 502 may additionally include an application mall link 508 operable to display the mall front 218.

The home screen 502 may additionally include applications which have been downloaded by the user from the mall front 218. For example, the illustrative device 500 indicates that the user has downloaded the Healthy Recipe Application 204(6) from the Martha's Cooking Store 210(1). In some instances, the home screen 502 may additionally include storefronts which have been downloaded by the user from the mall front 218. For example, the illustrative device 500 indicates that the user has downloaded the storefront of the Trainer Tim's Store 210(2). Downloading the storefront may enable the user to stay connected to the application store by receiving updates from the curator when new applications are made available. For instance, in the illustrative device 500, the storefront of the Trainer Tim's Store 210(2) includes an indicator 510 which may indicate that updates have been made to the Trainer Tim's Store 210(2). In order to learn more about the updates, the user may simply select the Trainer Tim's Store 210(2) directly from the home screen 502 to browse the Trainer Tim's Store 210(2) without having to go through the mall front 218.

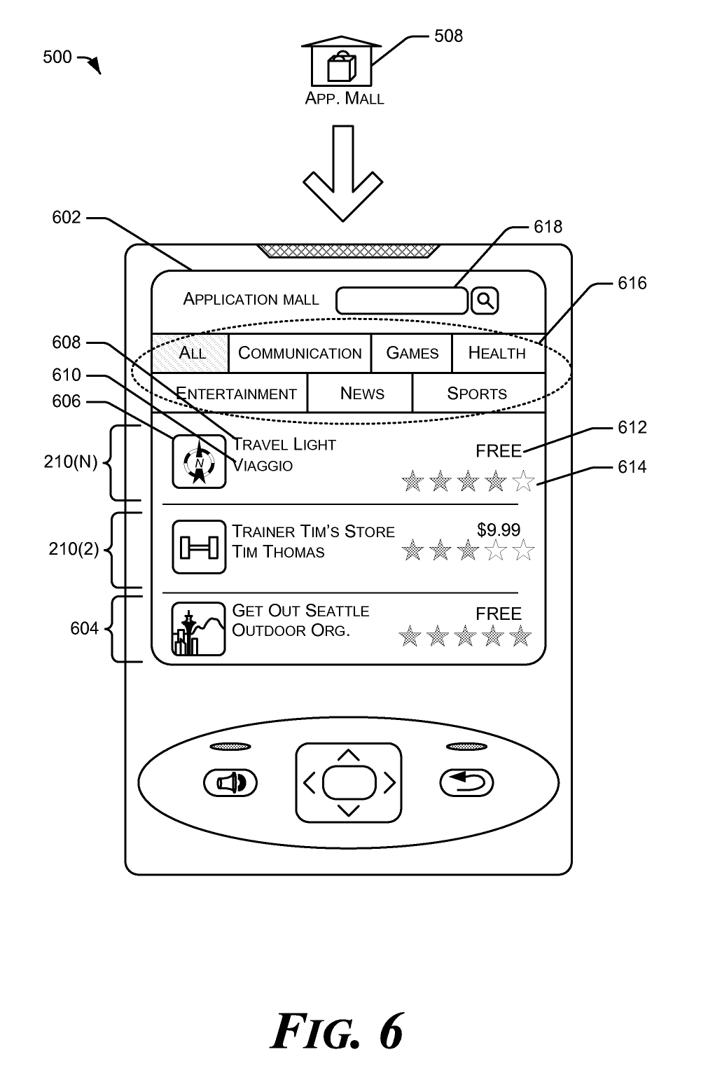

FIG. 6 is a front view of the illustrative device 500 that displays a mall front screen 602 to a display of the device. The mall front screen 602 may be displayed in response to the user 112 selecting the application mall link 508 from the home screen 502. The mall front screen 602 may include a listing of application stores such as the Travel Light Store 210(J), the Trainer Tim's Store 210(2), and a Get Out Seattle Store 604. Each application store may be displayed along with additional information such as a selectable icon 606 operable to generate a display of the respective application store, an application store name 608, and an application store curator 610, as depicted in the illustrative device 500 of FIG. 6, for example.

In some instances, each application store may be displayed with additional information such as an application store price 612 and an application store rating 614. For example, the Travel Light Store 210(J) may be free and may have a rating of 4 out of 5 stars. The application store price 612 may be a price to purchase a membership to browse the application store or it may be a price required to download a storefront of the application store. The application store rating 614 may be a rating provided by users purchasing items from the application store or simply users browsing through the application store.

The application stores listed in the mall front screen 602 may be retrieved from the store catalog 216. In some instances, the application stores listed in the mall front screen 602 are filtered prior to being displayed such that only compatible application stores are displayed to the mall front screen 602. The application stores may be filtered in accordance with the techniques discussed with respect to FIG. 4.

The mall front screen 602 may include a list of selectable categories 616 (e.g., “All,” “Communication,” “Games,” “Health,” “Entertainment,” “News,” “Sports,” etc.) so that the user may select a specific category to display only application stores of interest. In some instances, the mall front screen 602 may include a search input box 618 so that the user can search for application stores of interest using keywords.

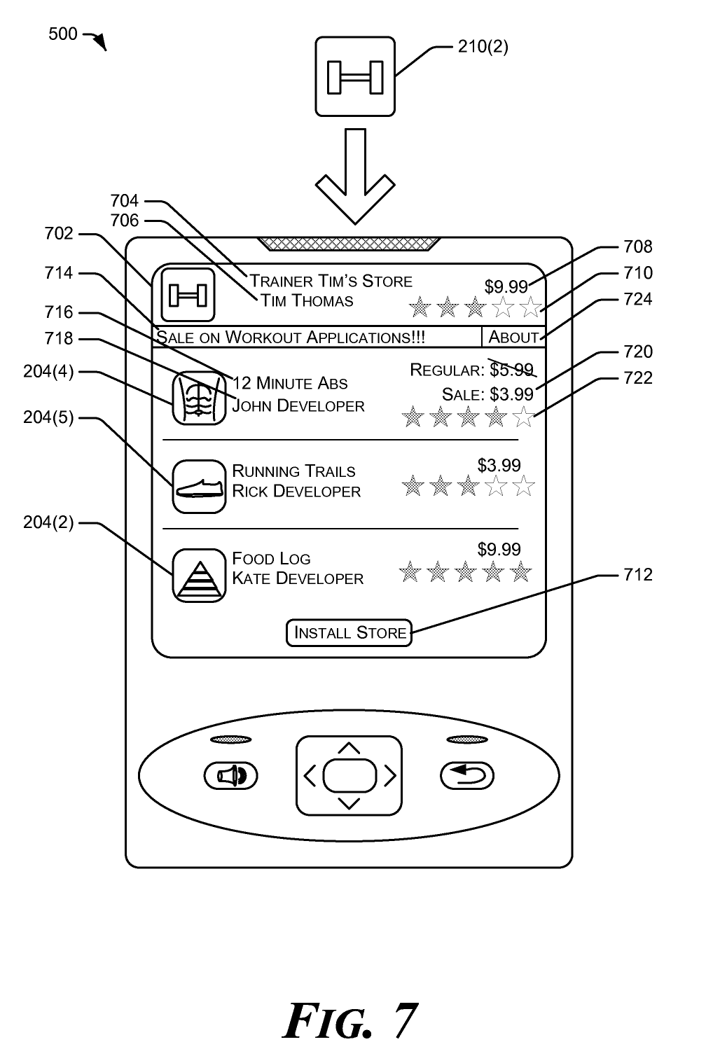

FIG. 7 is a front view of the illustrative device 500 that displays a storefront screen 702 to a display of the device. The storefront screen 702 may be displayed in response to the user 112 selecting one of the selectable icons of a respective application store from the mall front screen 602. For example, the user may select the dumbbell icon associated with the Trainer Tim's Store 210(2) from the mall front screen 602 to display the storefront screen 702 of FIG. 7.

The storefront screen 702 may include information associated with the selected application store such as a name of the application store 704 and a curator of the application store 706. For example, the illustrative Trainer Tim's storefront may list the name of the application store 704 as “Trainer Tim's Store” and the curator of the application store 706 as “Tim Thomas.” The storefront screen 702 may include additional information such as a price of the selected application store 708 and/or a rating of the selected application store 710. For example, the illustrative Trainer Tim's store may cost $9.99 and may have a rating of 3 out of 5 stars. The price of the selected application store 708 may be a storefront price (price to download the storefront such as to receive updates when new items are available from the application store or to create a shortcut access to the application store) or it may be a price required to browse the application store. For example, if the user 112 desires to purchase the Trainer Tim's Store 210(2), the user may select the install store option 712 and tender payment of the $9.99 price of the application store 708. The price of the selected application store 708 may vary (e.g., $2.00 for unlimited browsing and ¢50 for a one-time-browsing). In some instances, the storefront screen 702 may include a notification 714 from the curator 106 of the application store. The notification 714 may be used to communicate any sort of information to the user (e.g., mission statement, promotions, etc.).

In general, the storefront screen 702 includes a list of applications available from the selected application store. For example, the Trainer Tim's Store 210(2) may include the 12 Minute Abs Application 204(4), the Running Trail Finder Application 204(5), and the Food Log Application 204(2). The curator may procure the listed applications from the application database 206 to include in the Trainer Tim's Store. In some instances, the applications displayed to the storefront screen 702 are filtered such that only compatible applications are displayed. The applications may be filtered in accordance with the techniques discussed with respect to FIG. 4.

Each of the applications listed in the storefront screen 702 may include additional information such as a name of the application 716 and a developer of the application 718. For example, the “12 Minute Abs Application” 204(4) is depicted in the illustrative device 500 of FIG. 7 as having developer “John Developer.” In some instances, the applications are displayed along with additional information which may include a price of the application 720 and/or a rating of the application 722. For example, the “12 Minute Abs Application” 204(4) may have a sale price of $3.99 and a rating of 4 out of 5 stars. The price of the application 720 may be a price required to download the respective application from the curated store. The curator of the application store, the users who purchased from the application store or any combination thereof may provide the rating of the application 722. If a user desires to learn more about or purchase any of the applications listed, the user may simply select the icon associated with the respective Application.

The storefront screen 702 may have an option to view more information about the application store. For example, if the user 112 desires to view more information about the Trainer Tim's Store 210(2), he/she may select the “About Option” 724.

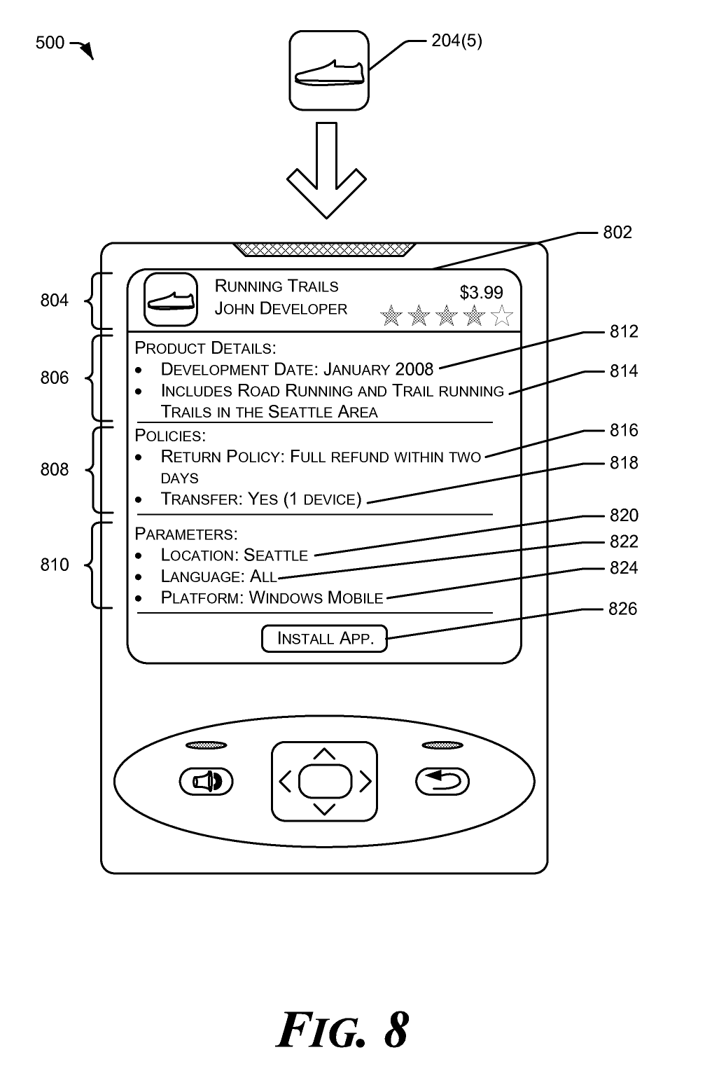

FIG. 8 is a front view of the illustrative device 500 that displays an application screen 802 to a display of the device. The application screen 802 may be displayed in response to the user 112 selecting one of the selectable icons of respective applications from the storefront screen 702. For example, the user 112 may click on the icon associated with the Running Trails Application 204(5) from the storefront screen 702 of FIG. 7 to display the application screen 802 of FIG. 8.

The application screen 802 may include sections of information such as an application overview section 804, a product detail section 806, an application policy section 808, and an application parameters section 810. The application overview section 804 may display information pertaining to the selected application. In some instances, the information displayed in the application overview section 804 is the same information that is available from the storefront screen 702 of FIG. 7 (e.g., the name of the application store 704, the curator of the application store 706, the price of the selected application store 708, and/or the rating of the selected application store 710).

The product detail section 806 may display information pertaining to specifics of the selected application such as application development data 812 and an application summary 814. In some instance, the product detail section 806 is provided by the developer of the selected application (i.e., provided by John Developer).

The application policy section 808 may display information pertaining to policies or customer support options associated with the selected application such as an application return policy 816 and an application transfer policy 818. The application return policy 816 may specify whether the user 112 may return the selected application after purchasing it. For example, if a user who purchases an application later determines that he does not like the application or that the application is not what he thought it was, then he may be able to return the purchased application back to the curator 106 if enabled by the return policy. The application transfer policy 818 may specify whether the user 112 may transfer the selected application to another target device after purchasing it. In some instance, the application policy section 808 is provided by the curator 106 of the selected application store (i.e., Tim Thomas).

The application parameters section 810 may display information pertaining to parameters associated with the selected application such as an application location tag 820, an application language tag 822, and an application platform tag 824. The application location tag 820 may indicate an area (e.g., town, city, state, country, region, universal, etc.) for which the application is intended for use. The application language tag 822 may indicate whether the application is of a specific language (e.g., English, Spanish, French, Chinese, etc.). The application platform tag 824 indicates whether the application is developed for a specific platform (e.g., “Microsoft® platform,” “Apple® platform,” “Android® platform,” “all,” etc.). The application parameters section 810 may include other parameters such as a role of a target user (e.g., “mother,” “student,” “caretaker,” etc.), an employer with which the application is associated, a time of which the application is relevant (e.g., time of day, month, year, season, etc.), etc.

The data in the application parameters section 810 may be used to filter the applications so that the user 112 is only able to see the compatible applications. For example, if the application platform tag 824 indicates that the Running Trails Application is only available on Windows® Phone platforms, and the illustrative device 500 is an Android® platform, then the user 112 will not be able to see or purchase the Running Trails Application when browsing the storefront screen 702 of the Trainer Tim's Store 210(2). As another example, if the application location tag 820 indicates that the Running Trails application only lists running trails in the Seattle area then the user will only be able to see the Running Trails application if the illustrative device 500 is located proximate the Seattle area.

The data in the application parameters section 810 may be provided by the developer of the selected application and/or by the curator of the application store.

The user 112 may purchase the selected application for use on the illustrative device 500 by selecting the install application option 826 and tendering payment of the application price.

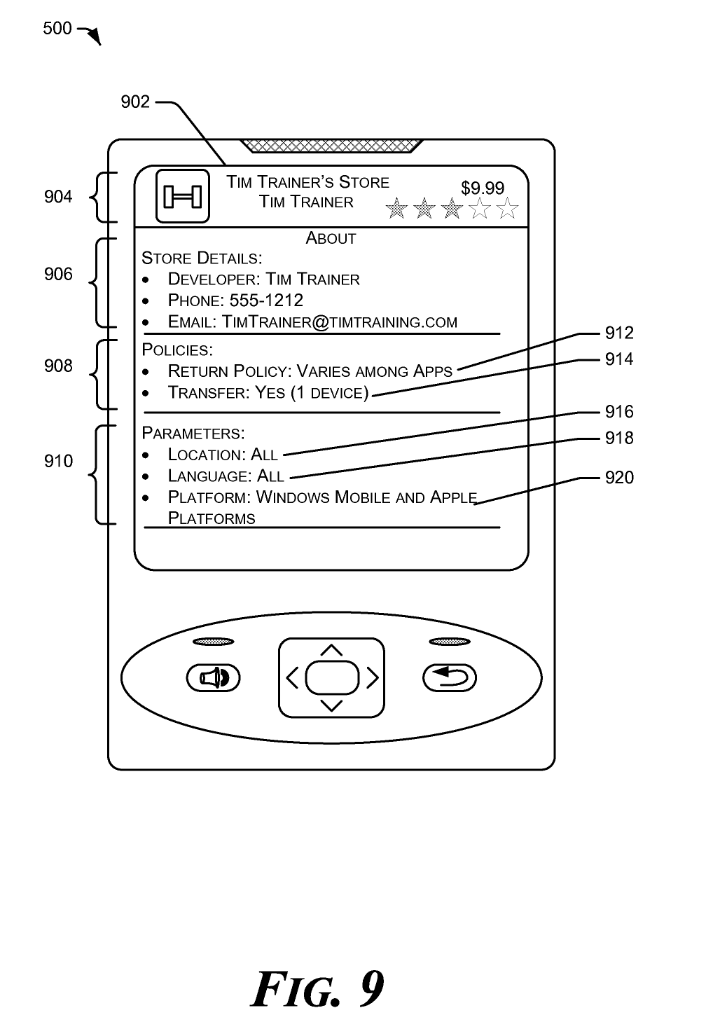

FIG. 9 is a front view of the illustrative device 500 that displays an application store about screen 902 to a display of the device. The application store about screen 902 may be displayed in response to the user 112 selecting the “About Option” 724 of the displayed storefront 702. The information available in the application store about screen 902 may be provided by the curator.

The application store about screen 902 may include sections of information such as a store overview section 904, a store detail section 906, a store policy section 908, and a store parameters section 910. The store overview section 904 may display information pertaining to the application store which is similar to the information that is available from the storefront screen 702 of FIG. 7.

The store detail section 906 may include contact information associated with the curator 106 of the application store 706 (i.e., Tim Thomas) such a phone number or Electronic Mail (“E-Mail”) address of the curator 106. The information provided in the store detail section 906 may enable the user 112 to contact the curator of the application store directly if they have any questions or concerns regarding the application store.

The store policy section 908 may display information pertaining to policies or customer support options associated with the application store such as a store return policy 912, a store transfer policy 914, or any combination thereof. The store return policy 912 and the store transfer policy 914 may specify general return and transfer policy information regarding applications purchased from within the application store. In some instances, all of the applications for sale within the application store may have the same application return policy 912. Thus, the user 112 may simple navigate to the store policy section 908 to view the return policy applicable for all purchases made from the application store. Alternatively, the application return policies may vary from application to application within an application store, in which case the user 112 may navigate to the specific application itself to find the application return policy.

The store parameters section 910 may display information pertaining to parameters associated with the application store such as a store location tag 916, a store language tag 918, and a store platform tag 920. The data in the store parameters section 910 may be used to filter the application stores that are displayed to the mall front screen 602 so that the user 112 is only able to see compatible application stores.

In some instances, the application store about screen 902 may include additional information. For instance, the application store about screen 902 may include information pertaining to a subscription policy of the application store. The curator may establish a subscription policy that enables users to “rent” the applications from the application store for a limited duration of time and then “trade-in” the old applications for replacement applications.

### Illustrative System

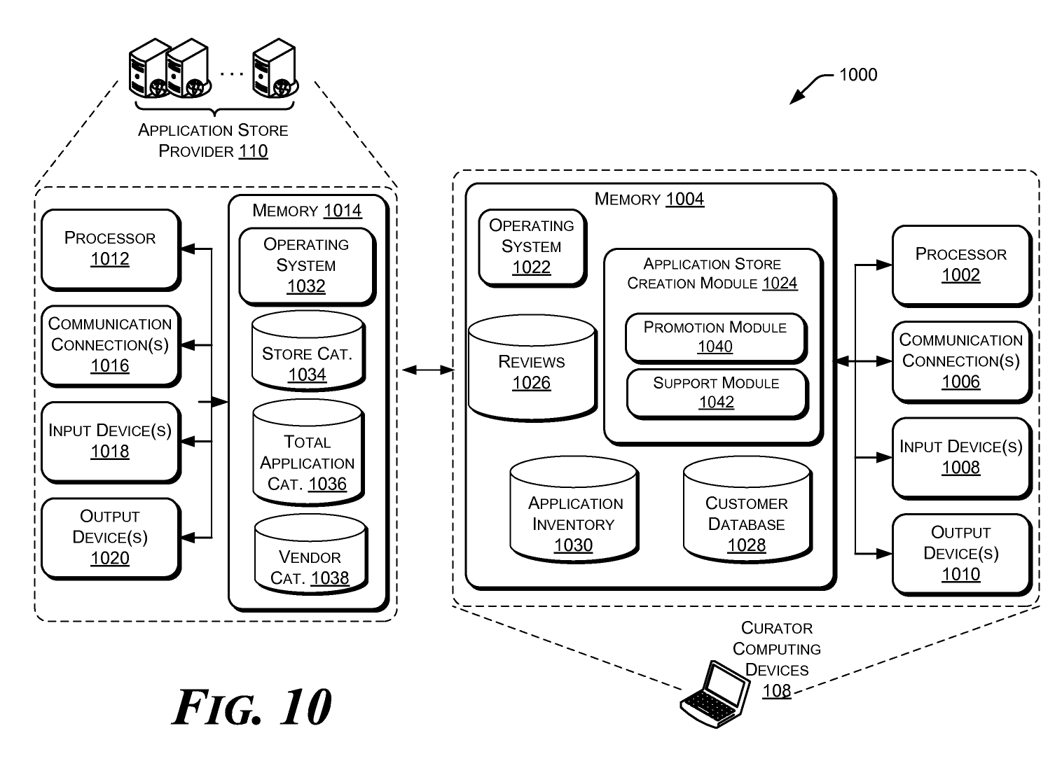

FIG. 10 is a block diagram of an illustrative system 1000 usable to create application stores, such as the application stores 210(1)-(J) of FIG. 2. The system 1000 may include the computing device 108 and the application store provider 110 of FIG. 1. The computing device 108 and the application store provider 110 may be operable to create and store the application stores 210(1)-(J). For instance, the computing device 108 may be operable to create the application stores 210(1)-(J) and the application store provider 110 may be operable to store the created application stores. The elements of the application store provider 110 are not restricted to residing to the computing device 108 and the application store provider 110, but rather may be implemented in the computing device, the application store provider 110, the application providers 102(1)-(N), or any combination thereof.

In one illustrative configuration, the computing device 108 comprises one or more processors 1002 and memory 1004. The computing device 108 may also contain communications connection(s) 1006 that allow the computing device 108 to communicate with other devices on the network 104 such as the application store provider 110, the application providers 102(1)-(N), the target device 114, or the alternative computing device 116. The computing device 108 may also include one or more input devices 1008 and one or more output devices 1010. The application store provider 110 may similarity comprise one or more processors 1012, memory 1014, communications connection(s) 1016 that allow the application store provider 110 to communicate with other devices on the network 104, one or more input devices 1018 and one or more output devices 1020. The input devices 1008, 1018 may be a keyboard, mouse, pen, voice input device, touch input device, etc., and the output devices 1010, 1020 may be a display, speakers, printer, etc. coupled communicatively to the processor 1002, 1012 and memory 1004, 1014.

The memory 1004 of the computing device 108 may store an operating system 1022, an application store curation module 1024, a reviews database 1026, a customer database 1028, and an application inventory database 1030. The memory 1014 of the application store provider 110 may store an operating system 1033, a store catalog 1034, a total application catalog 1036, and a vendor catalog 1038. The memory 1004 of the computing device 108 and memory 1014 of the application store provider 110, or portions thereof, may be implemented using any form of computer-readable media that is accessible by computing device 108 and the application store provider 110, respectively. Similarly, application store curation module 1024, or portions thereof, may be implemented using any form of computer-readable media that is accessible by computing device 108.

Computer-readable media includes, at least, two types of computer-readable media, namely computer storage media and communications media

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

The application store creation module 1024 of the computing device 108 may be configured to curate application stores such as the application stores 210(1)-(J) of FIG. 2 using the process 300 illustrated in FIG. 3. For instance, the curator 106 may procure one or more applications from the total application catalog 1036 and store the procured applications to the application inventory database 1030. The curated application stores may store any comments or reviews of the procured applications or the application store itself to the reviews database 1026. The application store creation module 1024 may then create the application store using a subset of the applications stored in the application 1030. The created application store may be stored to the store catalog where they are available to the users.

Information associated with the curator such as user generated reviews of the curators, contact information for the curators, sales history, etc. may be stored to the vendor catalog 1038 and may be used to rank the application stores and/or the curators of the application stores. Information pertaining to customers who either browse or purchase items from the application stores may be stored to the customer database 1028. For example, the customer database 1028 may include user profile information and/or purchase history information for the customers that browse or purchase items from the application stores.

The application store creation module 1024 may include additional modules that support the application store. For instance, the application store creation module 1024 may include a promotion module 1040 to help promote the application store via social networking outlets, for example. The application store creation module 1024 may additionally include a support module 1042 to support one or more of the application policies 808 and/or the application store policies 908.

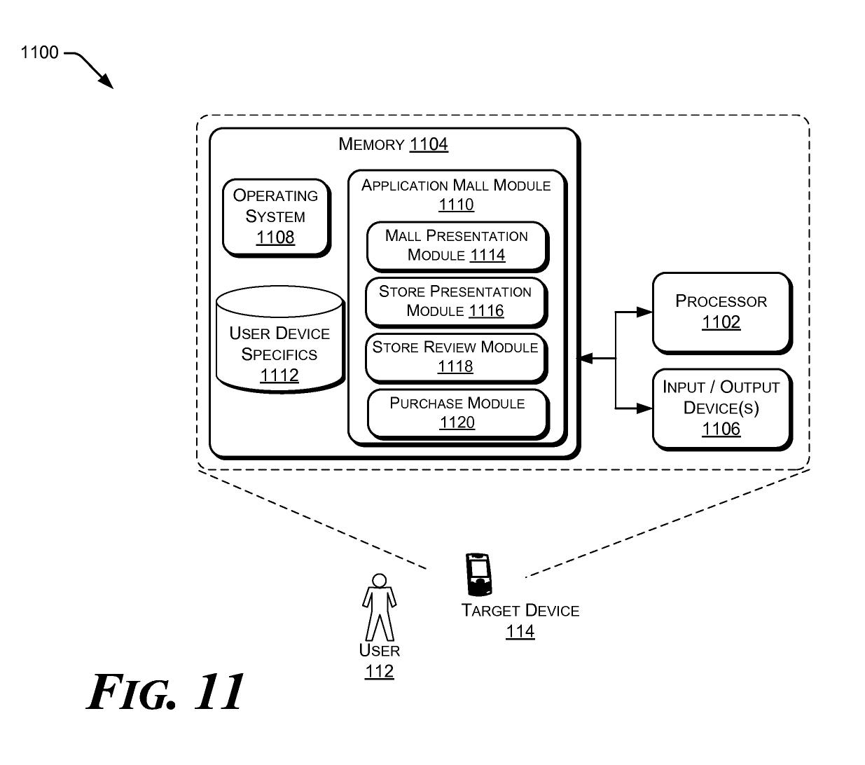

FIG. 11 is a block diagram of an illustrative system 1100 usable to browse through the application stores and receive downloads of purchased items from the application stores. The system 1100 may include the target device 114 of FIG. 1 that is operated by the user 110 to browse through the application stores.

In one illustrative configuration, the target device 114 comprises one or more processors 1102 and memory 1104. The target device 110 may also contain Input/Output devices 1106 such as a keyboard, mouse, pen, voice input device, touch input device, etc. that allow the user 110 to communicate with the target device 114 as well as allow the target device to communicate with other devices on the network 104.

The memory 1104 of the target device 114 may store an operating system 1108, an application mall module 1110, and a user device specifics database 1112. The memory 1104 of the target device 114, or portions thereof, may be implemented using any form of computer-readable media that is accessible by target device 114. Similarly, application mall module 1110, or portions thereof, may be implemented using any form of computer-readable media that is accessible by target device 114.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

The user device specifics database 1112 may store information pertaining to the target device 114 and/or the user 110 of the target device such as a location of the target device, a platform of the target device, a language preference, the user's age, a role of the user (e.g., “mother,” “student,” “caretaker,” etc.), an employer of the user, a time (e.g., time of day, month, year, season, etc.), a purchase history, user profiles (e.g., indicated likes or dislikes of the user), etc.

The application mall module 1110 may be configured to browse through application stores and/or purchase items from the application stores such as illustrated in FIG. 5-9. For instance, the application mall module 1110 may include a mall presentation module 1114 operable to receive application stores from the store catalog to display the mall front screen 602 to the target device 114. The mall presentation module 1114 may be operable to filter the application stores based on the data stored to the user device specifics database 1112 so that only the application stores which are compatible with the user and/or the target device are displayed. The application mall module 1110 may further include a store presentation module operable to display the storefront screen 702 of the application stores included in the mall front screen 602. Similar to the mall presentation module 1114, the store presentation module 1116 may filter the applications based on the data stored to the user device specifics database 1112 so that only the applications which are compatible with the user and/or the target device are displayed. The application mall module 1110 may further include a store review module 1118 operable to generate or store reviews of the applications and/or application stores. In addition, the application mall module 1110 may further include a purchase module 1120 operable to purchase or download items from the application store.

As noted above, the target device 114, the alternative computing device 116, the application store provider 110, or any other device storing curated application stores may be operable to download content purchased from a curated application store to the target device 114. Accordingly, the application mall module 1110, or portions thereof, may be implemented in the alternative computing device 116, the application store provider 110, or any other device storing curated application stores may be operable to download content purchased from a curated application store to the target device 114.

### CONCLUSION

Although the disclosure uses language specific to structural features and/or methodological acts, the invention is not limited to the specific features or acts described. Rather, the specific features and acts are disclosed as illustrative forms of implementing the invention.

What is claimed is:

1. One or more computer-readable media storing computer-executable instructions that, when executed by a processor of a computing device, configure the processor to perform acts comprising:
causing a display of a plurality of application stores;
receiving a selection of an application store from the plurality of application stores;
causing a display of a storefront of the selected application store, including a plurality of applications provisioned by a curator of the selected application store; and
receiving a selection of an item for purchase from the selected application store, the item selected purchase being for use on a target device.

2. The one or more computer-readable media of claim 1, further comprising receiving a selection of an application mall to cause the display of the plurality of application stores.

3. The one or more computer-readable media of claim 1, wherein the item selected for purchase is: (1) an application provisioned by the curator and/or (2) the selected application store.

4. The one or more computer-readable media of claim 1, where in the causing the display of the plurality of application stores includes filtering out application stores which are not compatible with a platform of the target device prior to the causing the display of the plurality of application stores.

5. The one or more computer-readable media of claim 1, wherein the causing the display of the storefront further includes filtering out applications provisioned by the curator which are not compatible with a platform of the target device prior to the causing the display of the storefront.

6. The one or more computer-readable media of claim 1, wherein the curator is a human curator and/or an organization.

7. The one or more computer-readable media of claim 1, wherein the plurality of application stores includes a corporation application store of which a user of the target device is an employee.

8. The one or more computer-readable media of claim 1, wherein the computer-executable instructions are resident to the target device.

9. The one or more computer-readable media of claim 8, further comprising causing a display of an icon associated with the item selected for purchase to the target device, the item selected for purchase being: (1) an application provisioned by the curator and/or (2) the selected application store.

10. The one or more computer-readable media of claim 9, further comprising causing display of an indicator proximate the icon, the item selected for purchase being the selected application store, the indicator indicating that the curator has added a new application to the purchased application store.

11. A method comprising:
under control of one or more processors configured with executable instructions:
provisioning a plurality of applications from an application database;
curating an application store to include a selection of applications from the provisioned applications, a curator of the application store being independent of a party administering the application database;
selling an application from the application store to a buyer; and
receiving a revenue share from the selling of the application.

12. The method of claim 11, further comprising generating a review and/or rating of at least one application included in the application store or of the application store itself.

13. The method of claim 11, wherein the curating the application store includes hand selecting the plurality of applications provisioned from the application database.

14. The method of claim 11, wherein the provisioning the plurality of applications includes paying a purchase price for each of the provisioned applications, wherein the purchase price to provision the application sold from the application store is different from the revenue share received from the selling the application.

15. The method of claim 11, wherein an appearance of the sold application as the sold application appears in the application database is different from an appearance of the sold application as it appears in the application store, the difference being a result of the curator branding the sold application prior to including the sold application in the application store.

16. The method of claim 11, further comprising associating a store policy with the application store, the store policy being a return policy, a transfer policy, and/or a subscription policy.

17. The method of claim 11, further comprising:
associating a subscription policy with the application store; and
enforcing the subscription policy, including:
receiving a subscription event from the buyer to remove an old application from a target device of the buyer, the subscription event indicating that the buyer desires to replace the old application, and/or an indication that a predetermined subscription time period has expired;
communicating a command to remove the old application from a target device of the buyer in response to the received subscription event; and
communicating a command to deliver a replacement application to the target device to replace the old application.

18. A method of organizing mobile applications into an application mall, the method comprising:
under control of one or more processors configured with executable instructions:
storing a plurality of application stores to a store catalog;
filtering the application stores based on a platform of a target device;
communicating the filtered application stores for display as a mall front at the target device;
filtering a plurality of applications provisioned by a curator of a selected application stores based on the platform of the target device;
communicating the filtered applications for display to a storefront at the target device; and
delivering an item purchased from the storefront to the target device.

19. The method of claim 18, wherein the item purchased from the storefront has an associated store policy, the store policy being a return policy, a transfer policy, and/or a subscription policy.

20. The method of claim 18, wherein the item purchased from the storefront has an associated return policy, the return policy enforced by removing the item purchased from the storefront from the target device.
